(19) United States
(12) Patent Application Publication
(10) Pub. No.: US 2026/0046246 A1
(43) Pub. Date: Feb. 12, 2026

(54) EXTERNAL CONTROLLER FOR IMPLEMENTING A MOBILE USER PLANE (MUP) OVER A SEGMENT ROUTING NETWORK

(71) Applicant: Arrcus Inc., San Jose, CA (US)

(72) Inventors: Keyur Patel, San Jose, CA (US); Tetsuya Murakami, San Jose, CA (US); Nalinaksh Pai, San Ramon, CA (US); Derek Man-Kit Yeung, Fremont, CA (US)

(21) Appl. No.: 19/216,219

(22) Filed: May 22, 2025

Related U.S. Application Data
(60) Provisional application No. 63/680,996, filed on Aug. 8, 2024.

(51) Int. Cl. H04L 45/00; H04L 45/02

(52) U.S. Cl. CPC H04L 45/566; H04L 45/04

(57) ABSTRACT

Mobile User Plane (MUP) is combined with routing, e.g., a forwarding policy, determined by an external operation system. A network environment includes an MUP-PE connected to a data network and an MUP-GW connected to a cellular communication base station, the MUP-PE and MUP-GW connected by an access network. An MUP-C obtains mobile session information for user equipment connected to the base station and an operation system modifies the mobile session information to obtain modified mobile session information, which is used by MUP-C to generate ST1 and ST2 routes The modified mobile session information may include a forwarding policy.

### RELATED APPLICATIONS

This application claims the benefit of U.S. Provisional Application Ser. No. 63/680,996, filed Aug. 8, 2024, and entitled “External Controller for SRv6 MUP”. The foregoing application is hereby incorporated by reference in its entirety.

### FIELD OF THE INVENTION

This application relates to an external controller for implementing a mobile user plane (MUP) over a segment routing (SR) network e.g., SRv6.

### BACKGROUND

The Mobile User Plane (MUP) is a protocol for routing packets received from user equipment (UE) in a cellular communication network over an internet protocol (IP) network. MUP integrates with user plane function (UPF) for managing a connection to the UE and a subscription associated with the UE with routing of packets over an IP network. It would be an advancement in the art to expand the capacity of networks to use MUP.

### BRIEF DESCRIPTION OF THE FIGURES

In order that the advantages of the invention will be readily understood, a more particular description of the invention briefly described above will be rendered by reference to specific embodiments illustrated in the appended drawings. Understanding that these drawings depict only typical embodiments of the invention and are not therefore to be considered limiting of its scope, the invention will be described and explained with additional specificity and detail through use of the accompanying drawings, in which:

FIG. 1 is a schematic block diagram of a network environment connected to a cellular communication network in accordance with an embodiment of the present invention;

FIG. 2 is a table illustrating the setup of an external forwarding policy for MUP in accordance with an embodiment of the present invention;

FIG. 3 is a table illustrating the publishing of routes to a user plane function (UPF) and user equipment (UE) in accordance with an embodiment of the present invention;

FIG. 4 is a schematic block diagram of a computer system suitable for implementing methods in accordance with embodiments of the present invention.

### DETAILED DESCRIPTION

It will be readily understood that the components of the invention, as generally described and illustrated in the Figures herein, could be arranged and designed in a wide variety of different configurations. Thus, the following more detailed description of the embodiments of the invention, as represented in the Figures, is not intended to limit the scope of the invention, as claimed, but is merely representative of certain examples of presently contemplated embodiments in accordance with the invention. The presently described embodiments will be best understood by reference to the drawings, wherein like parts are designated by like numerals throughout.

Embodiments in accordance with the invention may be embodied as an apparatus, method, or computer program product. Accordingly, the invention may take the form of an entirely hardware embodiment, an entirely software embodiment (including firmware, resident software, micro-code, etc.), or an embodiment combining software and hardware aspects that may all generally be referred to herein as a “module” or “system.” Furthermore, the invention may take the form of a computer program product embodied in any tangible medium of expression having computer-usable program code embodied in the medium.

Any combination of one or more computer-usable or computer-readable media may be utilized. For example, a computer-readable medium may include one or more of a portable computer diskette, a hard disk, a random access memory (RAM) device, a read-only memory (ROM) device, an erasable programmable read-only memory (EPROM or Flash memory) device, a portable compact disc read-only memory (CDROM), an optical storage device, and a magnetic storage device. In selected embodiments, a computer-readable medium may comprise any non-transitory medium that can contain, store, communicate, propagate, or transport the program for use by or in connection with the instruction execution system, apparatus, or device.

Computer program code for carrying out operations of the invention may be written in any combination of one or more programming languages, including an object-oriented programming language such as Java, Smalltalk, C++, or the like and conventional procedural programming languages, such as the “C” programming language or similar programming languages, and may also use descriptive or markup languages such as HTML, XML, JSON, and the like. The program code may execute entirely on a computer system as a stand-alone software package, on a stand-alone hardware unit, partly on a remote computer spaced some distance from the computer, or entirely on a remote computer or server. In the latter scenario, the remote computer may be connected to the computer through any type of network, including a local area network (LAN) or a wide area network (WAN), or the connection may be made to an external computer (for example, through the Internet using an Internet Service Provider).

The invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions or code. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a non-transitory computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

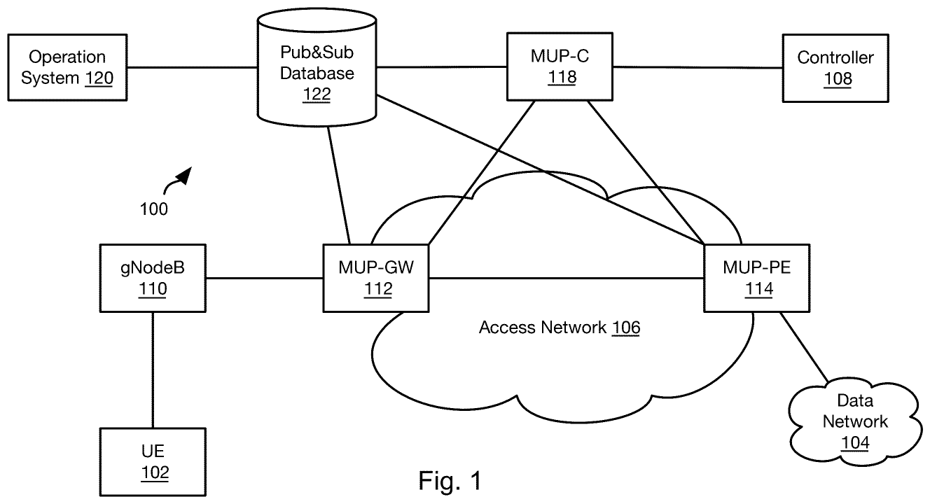

Referring to FIG. 1, the illustrated network environment 100 illustrates a connection between user equipment (UE) 102 and a data network 104, such as the Internet or other type of network, such as an internet protocol (IP) network. The UE 102 may connect to the data network 104 by way of an an access network (106). The access network 106 may further provide a connection between the UE 102 and a controller 108, e.g., a controller according to a cellular communication protocol, such as 4G, 5G, Long Term Evolution (LTE), or the like. The controller 108 may, for example, implement a user plane function (UPF) configured to manage a connection to the UE 102, including such things as quality of service (QoS), policy enforcement, and routing of traffic. The access network 106 may itself be an IP network such as a segment routing version 6 (SRv6) network.

Using the approach described herein, the routing of data between the UE 102 and the data network 106 over the access network 106 is performed using mobile user plane (MUP) protocol. In particular, the approach described herein enables routing according to MUP to be implemented with improved routing managed by an external controller.

MUP may be implemented using the illustrated components, each of which has the function ascribed therein according to the MUP protocol except as explicitly noted herein. The UE 102 may connect to the access network by way a base station, such as a gNodeB 110, which performs functions of receiving packets from the UE 102 by way of a radio antenna, encapsulating the packets into general packet radio service (GPRS) tunneling protocol (GTP) packets and forwarding the GTP packets to a MUP-enabled gateway 112 (MUP-GW 112) according to the approach described herein. The MUP-GW 112 may function as a gateway router and may be connected by the access network 106 to the data network 106 by a provider edge router 114 that is enabled to perform MUP (MUP-PE 114) according to the approach described herein.

Traffic to and from the UPF of the controller 108 may be routed by way of an MUP controller 118, such as a MUP-enabled control node (MUP-C) 118. The MUP-C 118 may be a control plane node in the MUP architecture responsible for creating and managing the routes within an MUP enabled networks, such as the access network 106. The MUP-C 118 may provide an interface to get session information from the 5G Core Control Plane, such as from the controller 108 or snooping traffic to and/or from the controller 108, and converts the session information into routing information for the data plane nodes, such as in the form of BGP routes.

External control of routing may be implemented using an operation system 120 configured to implement the functions ascribed thereto in the description below. The operation system 120 performs processing to determine routes between components of the illustrated network environment, such as between the MUP-PE 114 and the MUP-GW 112. The operation system 120 may be any executable code executing on any computing device. The operation system 120 may determine routes according to any routing algorithm known in the art.

The operation system 120 may operate in conjunction with a publisher and subscriber database 122 (hereinafter “database 122”). For example, components of the network environment 100 may publish data to the database 122 and subscribe to receive updates from the database 122 as described below. The database 122 may therefore provide a medium for sharing information among components of the network environment 100 as described below.

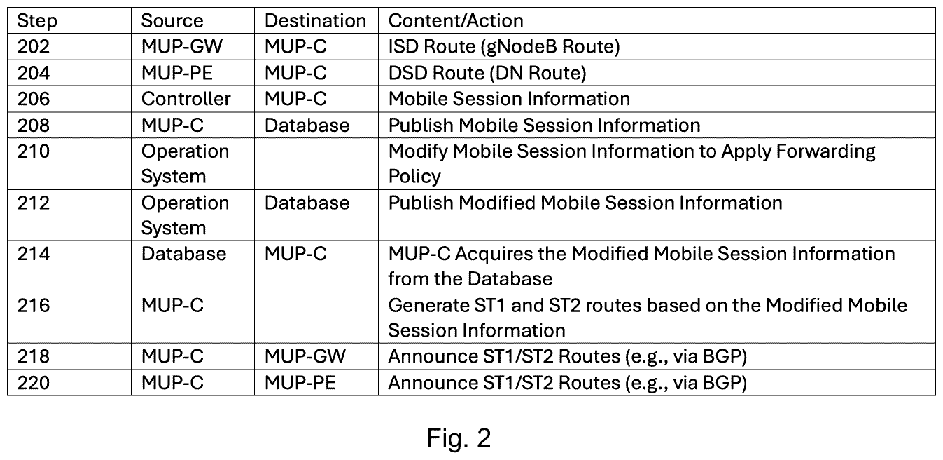

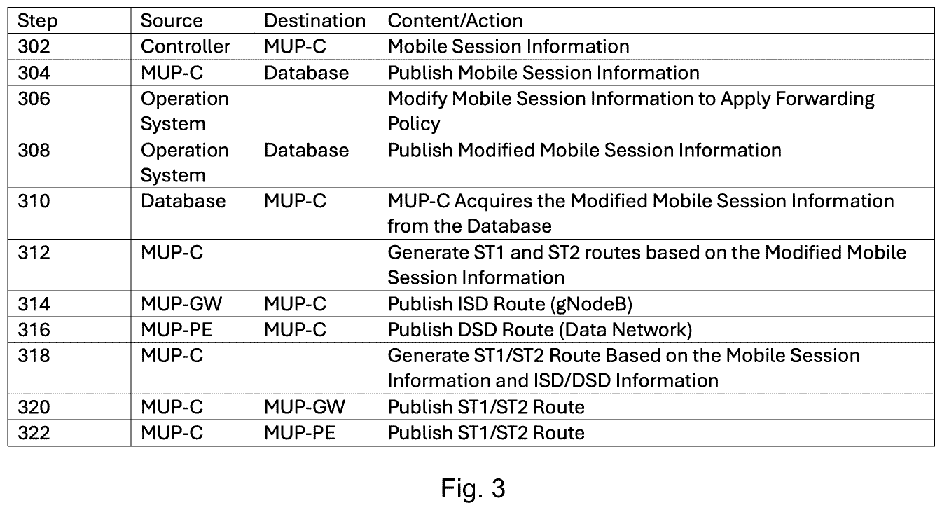

Referring to FIGS. 2 and 3, in cellular data communication networks that do not use MUP, gNodeB would transmit GTP packets to the UPF associated with a gateway. The UPF would then decapsulate the packets from GTP packets to IP packets and forward the IP packets to a gateway. MUP provides an improved approach that enables data packets to be transmitted to a gateway in bypass the UPF. Although MUP enables sharing of GTP information, MUP of itself is not able to implement more sophisticated routing to further facilitate transmission of data between the UE 102 and the data network 104.

The approach described below enables the benefits of MUP to be achieved while also enabling efficient routing of packets between the UE 102 and the data network 104.

The methods of FIGS. 2 and 3 may be proceeded by one or more discovery steps by MUP-GW 112, MUP-PE 114, and/or MUP-C 118 to generate constructs according to the MUP protocol (e.g., the MUP subsequent address family identifiers (MUP-SAFI or MUP-1)) as known in the art. For example, the MUP-GW 112 may perform internetwork segment discovery (ISD) to discover the address of gNodeB 110 (e.g. gNodeB prefix designated as gNB herein) and a segment identifier (SID) of a policy for performing GTP encapsulation and/or decapsulation (e.g., GTP 4/6.E SID), such as the locator for such an SID. The MUP-GW 112 may further configure the GTP 4/6.E locator on itself.

The methods of FIGS. 2 and 3 may be preceded by performing direct segment discovery (DSD) by the MUP-GW 112 to obtain information from MUP-PE 114 and/or vice versa. For example, DSD may be used to discover the data network 106, a DT4/6/46 or DX SID, an MUP-Extcomm, a DT 4/6 locator configured on MUP-GW 112 or MUP-PE 114.

ISD and DSD may be performed according to any approach known in the art. GTP 4/6.E SID, DT4/6/46, DX SID, DT 4/6, and MUP-Extcomm may be as defined according to the MUP protocol, such as according to MUP-1.

The methods of FIGS. 2 and 3 may be preceded by using packet forwarding control protocol (PFCP) by the MUP-C 118 to determine reachability information for the UE 102, e.g., by snooping control traffic between the UE 102 and the controller 108. For example, MUP-C 118 may discover type 1 session transformed (ST1) information, such as the address of the UE 102 (hereinafter “UE”), the gNodeB 110 address (“gNB”), the tunnel endpoint identifier (TEID) of a general packet radio service (GPRS) tunnel protocol (GTP) tunnel between gNodeB 110 and the UE 102, and quality of service flow identifier (QFI), and address of the UPF of the controller 108. The MUP-C 118 may also discover type 2 session transformed (ST2) information, such as a GTP tunnel (e.g., UPF and TEID) and MUP Extcomm attached (“Extcomm”).

Although described in greater detail, the approach described below may implement the following two aspects. First, the MUP-PE 114 combines an ST1 from MUP-C 118 and an N6 ISD from MUP-GW 112 to create a forwarding entry in the N6 VRF and invoke forwarding of packets to the UE 102 using the MPLS label from the ISD. Second, the MUP-GW 112 combines an ST1 from MUP-C 118 and a local N3 ISD to create a forwarding entry to forward packets to gNodeB 110 using GTP encapsulation based on the QFI, TEID, and gNB (gNodeB 110 address) from the ST1. In addition, VRF N6 ISD from the MUP-GW 112 carries the MPLS label. In VRF N3, the ISD from MUP-GW 112 is local and the MPLS label is not relevant.

Referring specifically to FIG. 2, the illustrated method may be performed to configure MUP components to implement an external forwarding policy, e.g., a policy for forwarding traffic from the UE 102 to the data network 104.

At step 202 the MUP-C 118 may discover the ISD route (e.g., route to the gNodeB 110) from the MUP-GW 112. At step 204, the MUP-C 118 may discover the DSD route (e.g., route to the data network 106) from the MUP-PE 114. At step 206, the MUP-C 118 may receive mobile session information from the controller 108. The mobile session information may include an address of the UE 102, and address of the gNodeB 110, GTP information for a GTP tunnel between the UE 102 and a UPF of the controller 108, e.g., tunnel endpoint identifier (TEID), quality flow identifier (QFI), or other information. The mobile session information may be obtained by snooping a PFCP session between the UE 102 and the UPF.

The MUP-C 118 may publish 208 the session information to the database 122 or otherwise communicate the session information to the operation system 120. The operation system 120 may retrieve the session information from the database 122 or receive the session information directly from the MUP-C 118. The operation system 120 may then modify 210 the mobile session information, such as to apply a forwarding policy. For example, the forwarding policy may define a path through the access network to the data network 104 from the MUP-GW 112. The forwarding policy may include one or more segment identifiers (SID), prefixes and policies associated with SIDs, next hop information, or any other routing information to define a route through the access network 106.

The operation system 120 may publish 212 the modified mobile session information to the database 122. The MUP-C 118 may acquire 214 the modified mobile session information from the database and generate 216 a type 1 session transformed (ST1) route and/or a type 2 session transformed (ST2) route based on the modified mobile session information. The ST1 route may further be a function of the ISD route and the ST2 route may further be a function of the DSD route. The ST1 route may define a route associated with a prefix (e.g., IP address) of the address of the UPF of the controller 108 and the ST2 route may define a route associated with the prefix (e.g., IP address) of the UE 102. The ST1 and ST2 routes may be defined according to the MUP protocol (e.g., the MUP subsequent address family identifiers (MUP-SAFI or MUP-1)).

The MUP-C 118 may announce 218, 220 the ST1 and ST2 routes to the MUP-PE 114 and/or MUP-GW 112. For example, the MUP-C may announce the ST1 route to the MUP-GW 112 and announce the ST2 route to the MUP-PE 114. The MUP-C 118 may announce the ST1 and ST2 routes in various ways:
A border gateway protocol (BGP) message.
A remote procedure call (RPC, e.g., a gRPC0.
Writing the ST1 and ST2 routes to the database 122, from which the MUP-PE 114 and/or MUP-GW 112 may retrieve the ST1 and/or ST2 routes.

Following execution of the method of FIG. 2, the MUP-GW 112 is configured to route traffic from the UE 102 and addressed to the data network 104 through the access network to the MUP-PE 114.

FIG. 3 illustrates a method for publishing routes for traffic addressed to the UE 102 and/or the UPF of the controller 108. At step 302, the MUP-C 118 may receive mobile session information from the controller 108. The mobile session information may include an address of the UE 102, and address of the gNodeB 110, GTP information for a GTP tunnel between the UE 102 and a UPF of the controller 108, e.g., tunnel endpoint identifier (TEID), quality flow identifier (QFI), or other information. The mobile session information may be obtained by snooping a PFCP session between the UE 102 and the UPF.

The MUP-C 118 may publish 304 the session information to the database 122 or otherwise communicate the session information to the operation system 120. The operation system 120 may retrieve the session information from the database 122 or receive the session information directly from the MUP-C 118. The operation system 120 may then modify 306 the mobile session information, such as to apply a forwarding policy. For example, the forwarding policy may define a path through the access network to the data network 104 from the MUP-PE 114 to the gNodeB 110. The forwarding policy may include one or more segment identifiers (SID), prefixes and policies associated with SIDs, next hop information, or any other routing information to define a route through the access network 106.

Steps 302 and 304 show that the MUP-C 118 in cooperation with the database 122 acts as a subscriber with respect to the controller 108 in order to receive mobile session information and modify the mobile session information for an existing mobile session (e.g., applying a specific forwarding policy) to implement MUP. Likewise, acting as a publisher enables the MUP-C 118 and database 122 to add new mobile sessions with respect to which MUP is performed without dependence on a mobile core system, e.g., gNodeB 110, MUP-GW 112, a user plane function (UPF), or other components of a cellular communication network.

The operation system 120 may publish 308 the modified mobile session information to the database 122. The MUP-C 118 may acquire 310 the modified mobile session information from the database and generate 312 a type 1 session transformed (ST1) route and/or a type 2 session transformed (ST2) route based on the modified mobile session information. The ST1 route may further be a function of the ISD route and the ST2 route may further be a function of the DSD route. The ST1 route may define a route associated with a prefix (e.g., IP address) of the address of the UPF of the controller 108 and the ST2 route may define a route associated with the prefix (e.g., IP address) of the UE 102. The ST1 and ST2 routes may be defined according to the MUP protocol (e.g., the MUP subsequent address family identifiers (MUP-SAFI or MUP-1)).

The MUP-GW 112 may publish 314 the ISD route (e.g., route to the gNodeB 110) to the MUP-C 118. The MUP-PE 114 may publish 316 the DSD route (e.g., route to the data network 104) to the MUP-C 118.

The MUP-C may then generate 318 an ST1 route and an ST2 route based on information from the ISD route, the DSD route, and the mobile session information, e.g., as originally received or as modified at step 308.

The MUP-C 118 may publish 320, 322 the ST1 and ST2 routes to the MUP-GW 112 and/or MUP-PE 114. For example, the MUP-C may publish 320 the ST1 route to the MUP-GW 112 and publish 322 the ST2 route to the MUP-PE 114. The MUP-C 118 may announce the ST1 and ST2 routes in various ways:
A border gateway protocol (BGP) message.
A remote procedure call (RPC, e.g., a gRPC0.
Writing the ST1 and ST2 routes to the database 122, from which the MUP-PE 114 and/or MUP-GW 112 may retrieve the ST1 and/or ST2 routes.

Following execution of the method of FIG. 3, the MUP-PE 114 is configured to route traffic from the data network 104 that is addressed to the UE 102 or UPF to the UE 102 by way of the MUP-GW 112 or to the UPF of the controller 108.

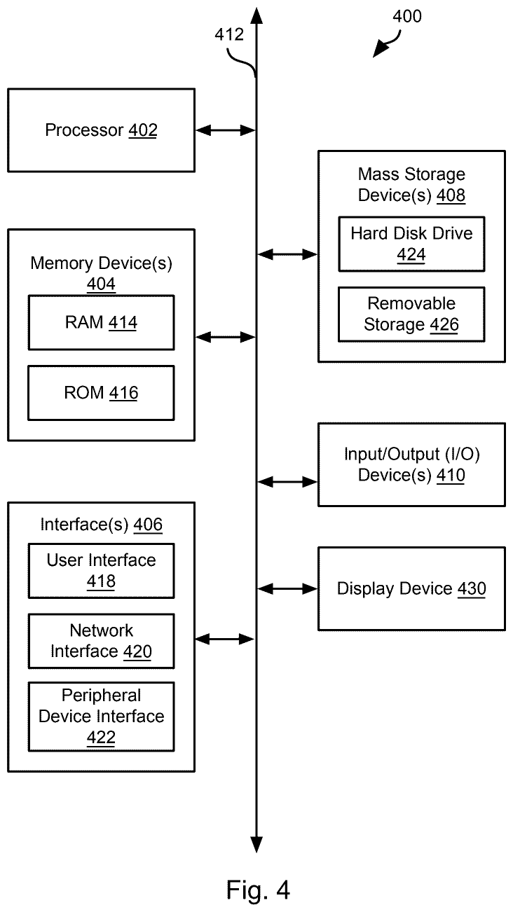

FIG. 4 is a block diagram illustrating an example computing device 400 which can be used to implement the system and methods disclosed herein, such as any of the UE 102, controller 108, gNodeB 110, MUP-GW 112, MUP-PE 114, operation system 120, database 122, or an endpoint in the data network 104. Computing device 400 can function as a server, a client, or any other computing entity. Computing device can perform various functions as discussed herein, and can execute one or more application programs, such as the application programs described herein. Computing device 400 can be any of a wide variety of computing devices, such as a desktop computer, a notebook computer, a server computer, a handheld computer, tablet computer and the like.

Computing device 400 includes one or more processor(s) 402, one or more memory device(s) 404, one or more interface(s) 406, one or more mass storage device(s) 408, one or more Input/Output (I/O) device(s) 410, and a display device 430 all of which are coupled to a bus 412. Processor(s) 402 include one or more processors or controllers that execute instructions stored in memory device(s) 404 and/or mass storage device(s) 408. Processor(s) 402 may also include various types of computer-readable media, such as cache memory.

Memory device(s) 404 include various computer-readable media, such as volatile memory (e.g., random access memory (RAM) 414) and/or nonvolatile memory (e.g., read-only memory (ROM) 416). Memory device(s) 404 may also include rewritable ROM, such as Flash memory.

Mass storage device(s) 408 include various computer readable media, such as magnetic tapes, magnetic disks, optical disks, solid-state memory (e.g., Flash memory), and so forth. As shown in FIG. 4, a particular mass storage device is a hard disk drive 424. Various drives may also be included in mass storage device(s) 408 to enable reading from and/or writing to the various computer readable media. Mass storage device(s) 408 include removable media 426 and/or non-removable media.

I/O device(s) 410 include various devices that allow data and/or other information to be input to or retrieved from computing device 400. Example I/O device(s) 410 include cursor control devices, keyboards, keypads, microphones, monitors or other display devices, speakers, printers, network interface cards, modems, lenses, CCDs or other image capture devices, and the like.

Display device 430 includes any type of device capable of displaying information to one or more users of computing device 400. Examples of display device 430 include a monitor, display terminal, video projection device, and the like.

Interface(s) 406 include various interfaces that allow computing device 400 to interact with other systems, devices, or computing environments. Example interface(s) 406 include any number of different network interfaces 420, such as interfaces to local area networks (LANs), wide area networks (WANs), wireless networks, and the Internet. Other interface(s) include user interface 418 and peripheral device interface 422. The interface(s) 406 may also include one or more user interface elements 418. The interface(s) 406 may also include one or more peripheral interfaces such as interfaces for printers, pointing devices (mice, track pad, etc.), keyboards, and the like.

Bus 412 allows processor(s) 402, memory device(s) 404, interface(s) 406, mass storage device(s) 408, and I/O device(s) 410 to communicate with one another, as well as other devices or components coupled to bus 412. Bus 412 represents one or more of several types of bus structures, such as a system bus, PCI bus, IEEE 1394 bus, USB bus, and so forth.

For purposes of illustration, programs and other executable program components are shown herein as discrete blocks, although it is understood that such programs and components may reside at various times in different storage components of computing device 400, and are executed by processor(s) 402. Alternatively, the systems and procedures described herein can be implemented in hardware, or a combination of hardware, software, and/or firmware. For example, one or more application specific integrated circuits (ASICs) can be programmed to carry out one or more of the systems and procedures described herein.

1. A method comprising:
providing an access network connecting a mobile user plane (MUP) provider edge router, MUP gateway router, and MUP controller to one another, the MUP gateway router being connected to a base station having a wireless connection to user equipment (UE) and the MUP provider edge router being connected to a data network;
receiving, by a mobile user plane (MUP) controller connected to the access network, mobile session information for the user equipment and base station;
modifying, by an operation system, the mobile session information to obtain modified mobile session information;
generating, by the MUP controller, a type 1 session transformed (ST1) route and a type 2 session transformed route (ST2) according to MUP protocol according to the modified mobile session information; and
providing, by the MUP controller, the ST1 route to the MUP gateway router and the ST2 route to the MUP provider edge router.

2. The method of claim 1, wherein the mobile session information includes a tunnel endpoint identifier (TEID) according to general packet radio service (GPRS) tunnel protocol (GTP).

3. The method of claim 2, wherein the mobile session information includes a quality flow identifier (QFI) according to GTP.

4. The method of claim 1, wherein the MUP controller is coupled to a user plane function (UPF) of a cellular communication controller, the method further comprising:
receiving, by the MUP controller, the mobile session information from packet forwarding control protocol (PFCP) traffic between the UE and the UPF.

5. The method of claim 1, further comprising:
publishing, by the MUP controller, the mobile session information to a publisher and subscriber database;
retrieving, by the operation system, the mobile session information from the publisher and subscriber database;
publishing, by the operation system, the modified mobile session information to the publisher and subscriber database; and
retrieving, by the MUP controller, the modified mobile session information from the publisher and subscriber database.

6. The method of claim 1, further comprising:
publishing, by the MUP gateway router, an internetwork segment discovery (ISD) message;
publishing, by the MUP provider edge router, direct segment discovery (DSD) message;
receiving, by the MUP controller, the ISD message and the DSD message; and
generating, by the MUP controller, the type 1 session transformed (ST1) route and the type 2 session transformed route (ST2) according to MUP protocol according to the modified mobile session information, the ISD message, and the DSD message.

7. The method of claim 1, wherein modifying the mobile session information to obtain modified mobile session information comprises modifying the mobile session information to include a forwarding policy.

8. The method of claim 7, wherein the forwarding policy defines forwarding from the UE to the data network.

9. The method of claim 7, wherein the forwarding policy defines forwarding from the data network to the UE.

10. The method of claim 1, wherein providing the ST1 route to the MUP gateway router and the ST2 route to the MUP provider edge router comprises using border gateway protocol (BGP).

11. A system comprising:
a network environment including:
a mobile user plane (MUP) provider edge router connected to a data network;
a base station configured to wirelessly connect to user equipment (UE);
a MUP gateway router connected to the base station;
an access network connecting the provider edge router to the MUP gateway router; and
a MUP controller; and
an operation system connected to the MUP controller;
wherein the network environment is configured to:
receive, by the mobile user plane (MUP) controller connected to the access network, mobile session information for the user equipment and base station;
modify, by the operation system, the mobile session information to obtain modified mobile session information;
generate, by the MUP controller, a type 1 session transformed (ST1) route and a type 2 session transformed route (ST2) according to MUP protocol according to the modified mobile session information; and
provide, by the MUP controller, the ST1 route to the MUP gateway router and the ST2 route to the MUP provider edge router.

12. The system of claim 11, wherein the mobile session information includes a tunnel endpoint identifier (TEID) according to general packet radio service (GPRS) tunnel protocol (GTP).

13. The system of claim 12, wherein the mobile session information includes a quality flow identifier (QFI) according to GTP.

14. The system of claim 11, wherein the MUP controller is coupled to a user plane function (UPF) of a cellular communication controller, the MUP controller further configured to:
receive the mobile session information from packet forwarding control protocol (PFCP) traffic between the UE and the UPF.

15. The system of claim 11, wherein the network environment is further configured to:
publish, by the MUP controller, the mobile session information to a publisher and subscriber database;
retrieve, by the operation system, the mobile session information from the publisher and subscriber database;
publish, by the operation system, the modified mobile session information to the publisher and subscriber database; and
retrieve, by the MUP controller, the modified mobile session information from the publisher and subscriber database.

16. The system of claim 11, wherein the network environment is further configured to:
publish, by the MUP gateway router, an internetwork segment discovery (ISD) message;
publish, by the MUP provider edge router, direct segment discovery (DSD) message;
receive, by the MUP controller, the ISD message and the DSD message; and
generate, by the MUP controller, the type 1 session transformed (ST1) route and the type session transformed route (ST2) according to MUP protocol according to the modified mobile session information, the ISD message, and the DSD message.

17. The system of claim 11, wherein the operation system is configured to modify the mobile session information to obtain modified mobile session information by modifying the mobile session information to include a forwarding policy.

18. The system of claim 17, wherein the forwarding policy defines forwarding from the UE to the data network.

19. The system of claim 17, wherein the forwarding policy defines forwarding from the data network to the UE.

20. The system of claim 11, wherein MUP controller is configured to provide the ST1 route to the MUP gateway router and the ST2 route to the MUP provider edge router using border gateway protocol (BGP).
